(19) United States
(12) Patent Application Publication
(10) Pub. No.: US 2015/0331222 A1
(43) Pub. Date: Nov. 19, 2015

(54) OPTICAL IMAGE PICK-UP LENS

(71) Applicant: CALIN TECHNOLOGY CO., LTD., Taichung City (TW)

(72) Inventors: Yi-Ling YANG, Taichung City (TW); Shu-Chuan HSU, Taichung City (TW)

(73) Assignee: CALIN TECHNOLOGY CO., LTD., Taichung City (TW)

(21) Appl. No.: 14/279,055

(22) Filed: May 15, 2014

(51) Int. Cl. G02B 13/00; G02B 9/34

(52) U.S. Cl. CPC G02B 13/004; G02B 9/34; G02B 13/009

(57) ABSTRACT

An optical image pick-up lens includes an aperture, a first lens, a second lens, a third lens, and a fourth lens in order along an optical axis from an object side to an image side. The first lens is a positive plastic meniscus lens having a convex surface facing the object side and a concave surface facing the image side. The second lens is a negative plastic biconcave lens. The third lens is a positive glass meniscus lens having a concave surface facing the object side and a convex surface facing the image side. The fourth lens is a plastic lens having an aspheric surface facing the object side, wherein the fourth lens is gradually changed from positive to negative from the center to the edge of the fourth lens.

### BACKGROUND OF THE INVENTION

1. Field of the Invention

The present invention relates generally to a lens, and more particularly to an optical image pick-up lens.

2. Description of the Related Art

With advancement in technology, image devices, such as camera, video camera, microscope, and scanner, are made smaller and lighter for portability and operation that the zoom lenses incorporated in such image devices have to reduce its size. Except that, the lenses must have high optical performance, such as high zoom ratio, high resolution, and high contrast. Therefore, small size and high optical performance are the important facts of the modern lenses.

The common conventional optical sensors in the image devices include charge coupled device (CCD) and complementary metal oxide semiconductor (CMOS), wherein the commonest optical sensor is CMOS because of its low cost, low power consumption, and high integration. However, with advancement in semiconductor technology, the modern optical sensor has a high density of pixels, so that each pixel receives less light than the conventional device. Therefore, the modern lens should be capable of increasing the light enter efficiency and lowering the noise.

Furthermore, the size of the image device is made as small as possible, so that the lens and the optical sensor are asked to reduce their sizes. As the density of the pixels is getting higher, the higher optical performance of the lens should be provided to match the optical sensor. Therefore, small size and high optical performance are two important issues in the modern lens.

In addition, the performance of the lens in wide-angle is getting important than ever, so that the problems of angle of wide-angle, distortion, and chromatic aberration have a high influence on the performance of the lens.

### SUMMARY OF THE INVENTION

The primary objective of the present invention is to provide an optical image pick-up lens, which has a small size, a high light enter efficiency, and a high performance in the wide-angle mode.

According to the objective of the present invention, the present invention provides an optical image pick-up lens, in order along an optical axis from an object side to an image side, including an aperture, a first lens, a second lens, a third lens, and a fourth lens. The first lens is a positive plastic meniscus lens having a convex surface facing the object side and a concave surface facing the image side, wherein at least one of the surfaces of the first lens is aspheric. The second lens is a negative plastic biconcave lens having at least an aspheric surface. The third lens is a positive glass meniscus lens having a concave surface facing the object side and a convex surface facing the image side, wherein at least one of the surfaces of the third lens is aspheric. The fourth lens is a plastic lens having an aspheric surface facing the object side, wherein the aspheric surface has an inflection portion, so that the fourth lens is gradually changed from positive to negative from a center, where the optical axis passes, to an edge of the fourth lens.

In an embodiment, wherein the optical image pick-up lens satisfies:

1.7≦Nd3

where Nd3 is a refractive index of the third lens.

With the design of above, the optical image pick-up lens has several characters, including small size, wide angle, less distortion, and high optical performance.

### BRIEF DESCRIPTION OF THE DRAWINGS

FIG. 1 is a sketch diagram of the arrangement of the lenses of a first preferred embodiment of the present invention;

FIG. 2A is a field curvature diagram of the first preferred embodiment of the present invention in the wide-angle mode;

FIG. 2B is a distortion diagram of the first preferred embodiment of the present invention;

FIG. 2C is a chromatic aberration of magnification diagram of the first preferred embodiment of the present invention in the wide-angle mode;

FIG. 2D is a spherical chromatic aberration diagram of the first preferred embodiment of the present invention in the wide-angle mode;

FIG. 3 is a sketch diagram of the arrangement of the lenses of a second preferred embodiment of the present invention;

FIG. 4A is a field curvature diagram of the second preferred embodiment of the present invention;

FIG. 4B is a distortion diagram of the second preferred embodiment of second present invention;

FIG. 4C is a chromatic aberration of magnification diagram of the second preferred embodiment of the present invention in the wide-angle mode;

FIG. 4D is a spherical chromatic aberration diagram of the second preferred embodiment of the present invention in the wide-angle mode;

FIG. 5 is a sketch diagram of the arrangement of the lenses of a third preferred embodiment of the present invention;

FIG. 6A is a field curvature diagram of the third preferred embodiment of the present invention;

FIG. 6B is a distortion diagram of the third preferred embodiment of second present invention;

FIG. 6C is a chromatic aberration of magnification diagram of the third preferred embodiment of the present invention in the wide-angle mode;

FIG. 6D is a spherical chromatic aberration diagram of the third preferred embodiment of the present invention in the wide-angle mode;

FIG. 7 is a sketch diagram of the arrangement of the lenses of a fourth preferred embodiment of the present invention;

FIG. 8A is a field curvature diagram of the fourth preferred embodiment of the present invention;

FIG. 8B is a distortion diagram of the fourth preferred embodiment of second present invention;

FIG. 8C is a chromatic aberration of magnification diagram of the fourth preferred embodiment of the present invention in the wide-angle mode; and

FIG. 8D is a spherical chromatic aberration diagram of the fourth preferred embodiment of the present invention in the wide-angle mode.

### DETAILED DESCRIPTION OF THE INVENTION

### First Preferred Embodiment

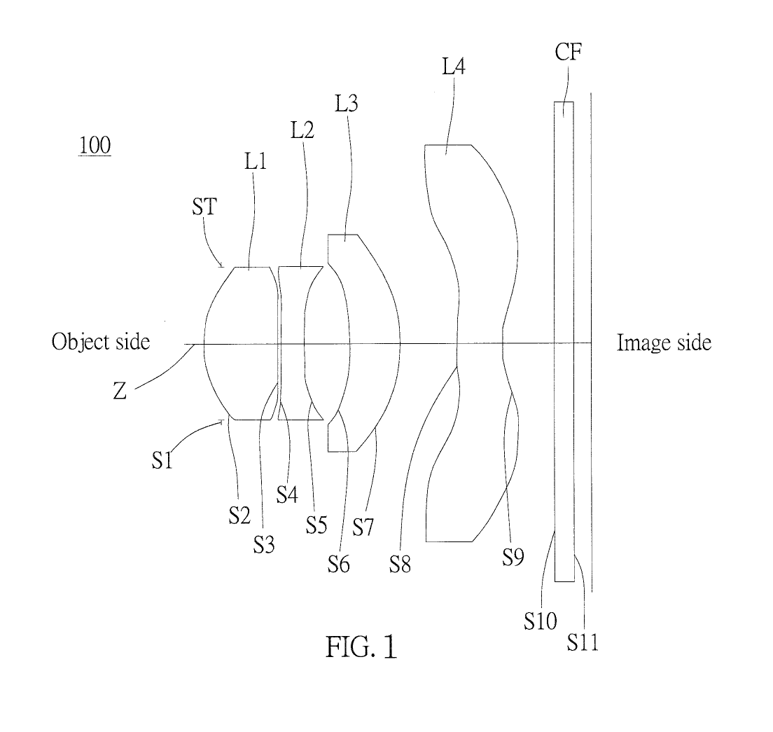

As shown in FIG. 1, an optical image pick-up lens 100 of the first preferred embodiment of the present includes, along an optical axis Z from an object side to an image side, an aperture ST, a first lens L1, a second lens L2, a third lens L3, and a fourth lens L4. It may be further provided with an optical filter CF between the fourth lens L4 and the image side to filter the noise and increase the optical performance.

The first lens L1 is a positive plastic lens. In an embodiment, the first lens L1 is a meniscus lens having a convex surface S2 facing the object side and a concave surface S3 facing the image side. It provides the optical image pick-up lens 100 with a wide-angle mode. Both surfaces S2, S3 of the first lens L1 are aspheric surfaces to effectively fix the torsion problem in the wide-angle mode.

The second lens L2 is a negative plastic lens. In an embodiment, the second lens L2 is a biconcave lens with two aspheric surfaces S4, S5.

The third lens L3 is a positive glass lens. In an embodiment, the third lens L3 is a meniscus lens having a concave surface S6 facing the object side and a convex surface S7 facing the image side. Both surfaces S6, S7 of the third lens L3 are aspheric surfaces.

The fourth lens L4 is a plastic lens. In an embodiment, the fourth lens L4 has an aspheric surface S8 facing the object side, and the surface S8 has two inflection portions. Therefore, the surface S8 has a convex portion within the proximal inflection portion, a concave portion between the inflection portions, and a convex portion between the distal inflection portion and an edge of the lens L4. In other words, a radius of curvature of the surface S8 is gradually changed from positive to negative, and then changed to positive again from a center, where the optical axis Z passes through, to an edge of the fourth lens L4. The fourth lens L4 has an aspheric surface S9 facing the image side, and the surface S9 has an inflection portion. Therefore, the surface S9 has a concave portion within the inflection portion and a convex portion between the inflection portion and the edge of the lens. As a result, the fourth lens L4 is negative at a central portion, and is positive at a margin portion. In other words, the fourth lens L4 is gradually changed from negative to positive from the center to the edge.

The optical image pick-up lens 100 further has the following characters:

1.7≦Nd3 (1)

2.35<f/R1<2.73 (2)

0.27<f1/f3<1.08 (3)

0.39<f/f3<1.15 (4)

0.83<f/TLL<0.88 (5)

where

Nd3 is the refractive index of the third lens L3;

f is the total focus length of the optical image pick-up lens 100;

R1 is the radius of curvature of the point on the surface S2 facing the object side of the first lens L1 where the optical axis Z passes;

f1 is the focus length of the first lens L1

f3 is the focus length of the third lens L3; and

TTL is the total length of the optical image pick-up lens 100.

In order to obtain a good optical performance, the focus length (f) of the optical image pick-up lens 100, the radius of curvature at the optical axis of each lens (R), the distance from the surface of the lens to the surface of the next lens (or to an image plane) (D), the refractive indexes of the lenses (Nd), and the Abbe number of the lenses (Vd) of the optical image pick-up lens 100 are shown in Table 1.

TABLE 1
f = 3.71 mm

| surface | R(mm) | D(mm) | material | Nd | Vd | Focus length | |
|---|---|---|---|---|---|---|---|
| S1 | ∞ | −0.090 | | | | | ST |
| S2 | 1.360 | 0.778 | plastic | 1.53 | 55.75 | 2.70 | L1 |
| S3 | 24.887 | 0.040 | | | | | |
| S4 | −55.276 | 0.249 | plastic | 1.64 | 22.46 | −6.22 | L2 |
| S5 | 4.363 | 0.500 | | | | | |
| S6 | −2.979 | 0.553 | glass | 1.81 | 40.95 | 8.94 | L3 |
| S7 | −2.290 | 0.600 | | | | | |
| S8 | 2.108 | 0.485 | plastic | 1.53 | 55.75 | −5.63 | L4 |
| S9 | 1.140 | 0.510 | | | | | |
| S10 | ∞ | 0.210 | glass | 1.5168 | 64.1 | | CF |
| S11 | ∞ | 0.298 | | | | | |

The depression z of the aspheric surfaces S2-S9 may be obtained by the following equation:

$$z = \frac{{ch}^{2}}{1 + \sqrt{1 - ( 1 + k ) {c}^{2} {h}^{2}}} + {α}_{2} {h}^{4} + {α}_{3} {h}^{6} + {α}_{4} {h}^{8} + {α}_{5} {h}^{10} + {α}_{6} {h}^{12}$$

where

z is the depression of the aspheric surface;

c is the reciprocal of radius of curvature;

h is the radius of aperture on the surface;

k is conic constant;

α2-α6 are coefficients of the radius of aperture h.

The conic constants (k) of the aspheric surfaces and the coefficients α2-α6 are shown in Table 2.

TABLE 2

| | S2 | S3 | S4 | S5 |
|---|---|---|---|---|
| K | 5.90545E−02 | 0.00000E+00 | 0.00000E+00 | −3.11721E+00 |
| α2 | −2.35819E−02 | 4.77610E−02 | 1.14048E−01 | 1.52990E−01 |
| α3 | 1.01412E−01 | −5.27749E−01 | −5.15545E−01 | −1.65837E−01 |
| α4 | −3.20450E−01 | 6.71737E−01 | 6.31481E−01 | 5.10999E−01 |
| α5 | 4.42882E−01 | −4.11789E−01 | −2.95348E−01 | −7.05961E−01 |
| α6 | −2.63893E−01 | 4.22178E−02 | 8.86422E−05 | 5.00936E−01 |
| | S6 | S7 | S8 | S9 |
| K | −1.32154E+02 | −4.33841E−01 | −1.10822E+01 | −6.12671E+00 |
| α2 | −4.63112E−01 | −1.14070E−01 | −3.85937E−01 | −1.61324E−01 |
| α3 | 9.95631E−01 | 1.06734E−01 | 2.12148E−01 | 6.84698E−02 |
| α4 | −1.71705E+00 | −9.11390E−02 | −5.25316E−02 | −1.77389E−02 |
| α5 | 1.67794E+00 | 7.40476E−02 | 6.51590E−03 | 2.51108E−03 |
| α6 | −7.09803E−01 | −2.39668E−02 | −3.32057E−04 | −1.41777E−04 |

With the designation of the lenses, the optical image pick-up lens 100 may work in wide-angle mode and has a short total length. Because the third lens L3 is made of glass, and its refractive index is greater than 1.7, it makes the optical image pick-up lens 100 have a high precision in optical axis calibration. Therefore, the optical image pick-up lens 100 would be helpful to a high definition and high quality of the image.

In an embodiment, the optical image pick-up lens 100 has the following characters:

Nd3=1.81 (1)

f/R1=2.728 (2)

f1/f3=0.302 (3)

f/f3=0.415 (4)

f/TLL=0.879 (5)

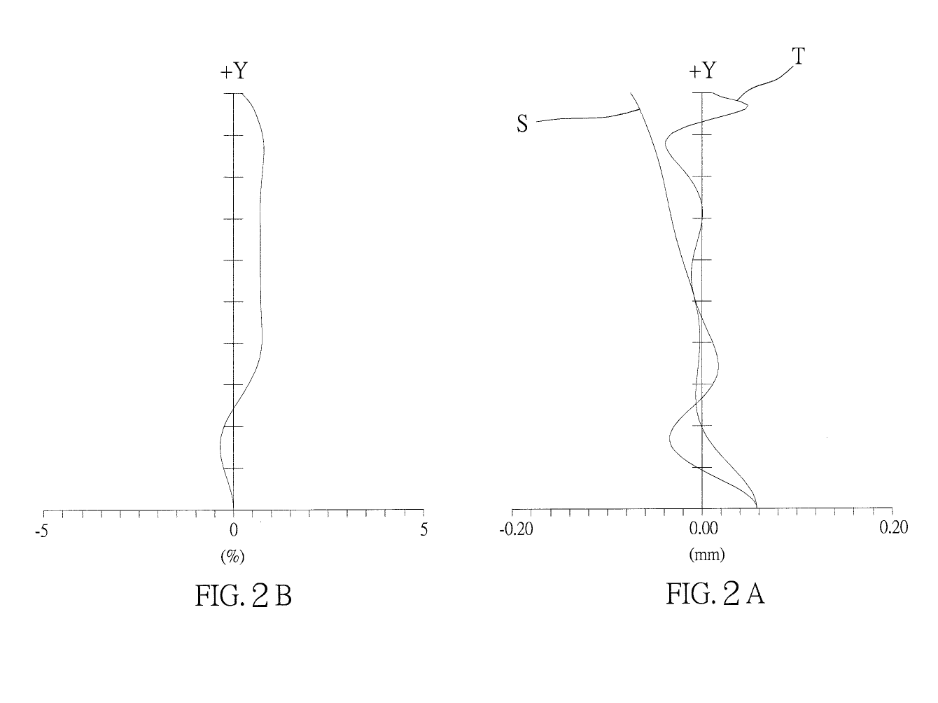

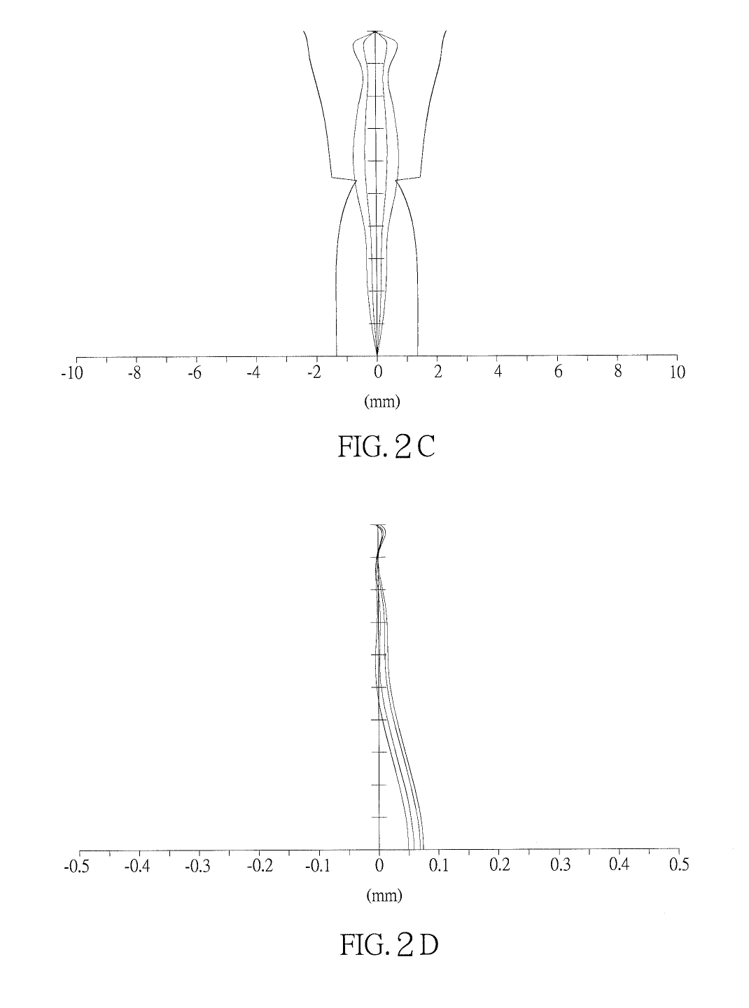

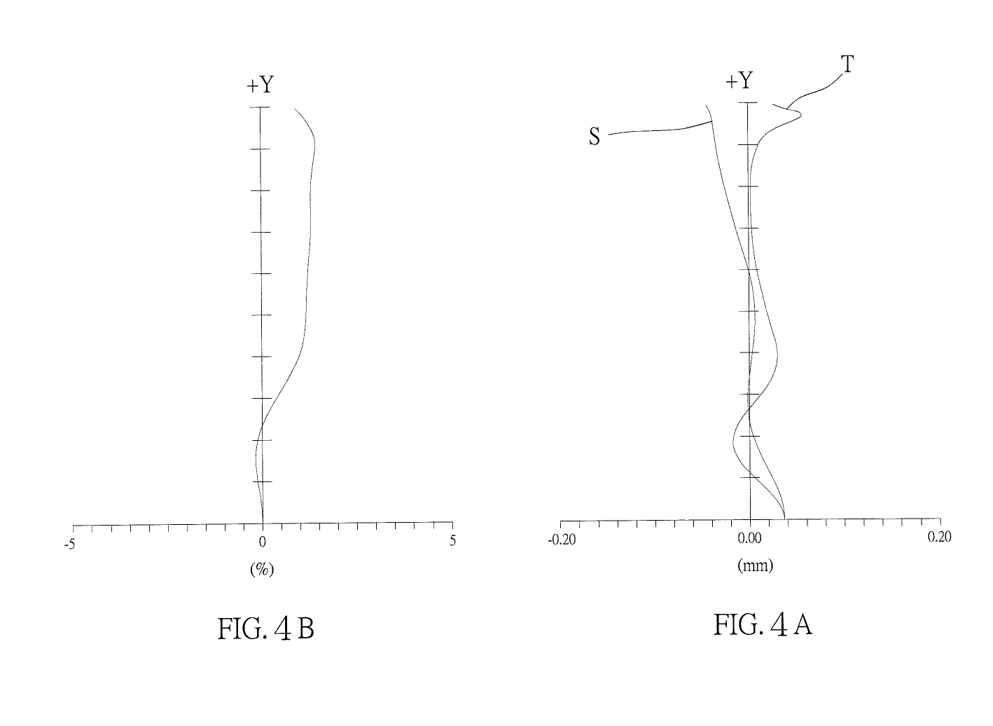

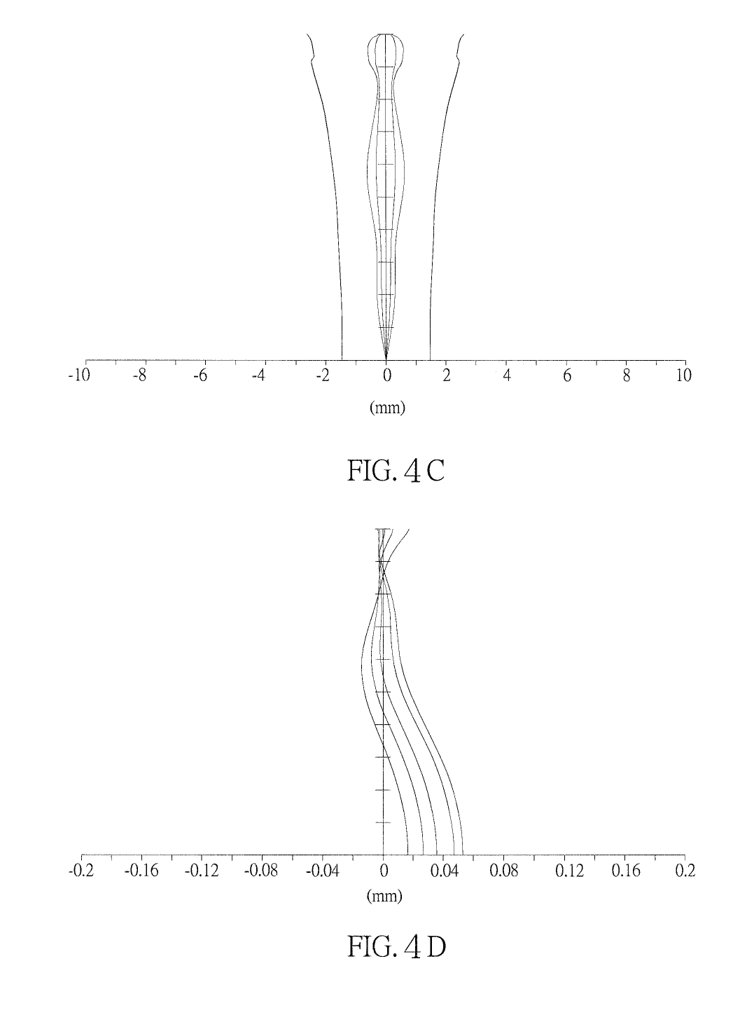

With the arrangement of the aperture ST and the lenses L1-L4, the optical image pick-up lens 100 would have a high performance in imaging. The maximum field curvature is about −0.008 mm and 0.06 mm (FIG. 2A), the maximum distortion is about −1% and 1% (FIG. 2B), the maximum chromatic aberration of magnification is about −3 μm and 3 μm (FIG. 2C), and the maximum spherical chromatic aberration is about −0.05 mm and 0.1 mm (FIG. 4D). In conclusion, according to the results shown in FIG. 2A to FIG. 2D, the optical image pick-up lens 100 has a high optical performance.

### Second Preferred Embodiment

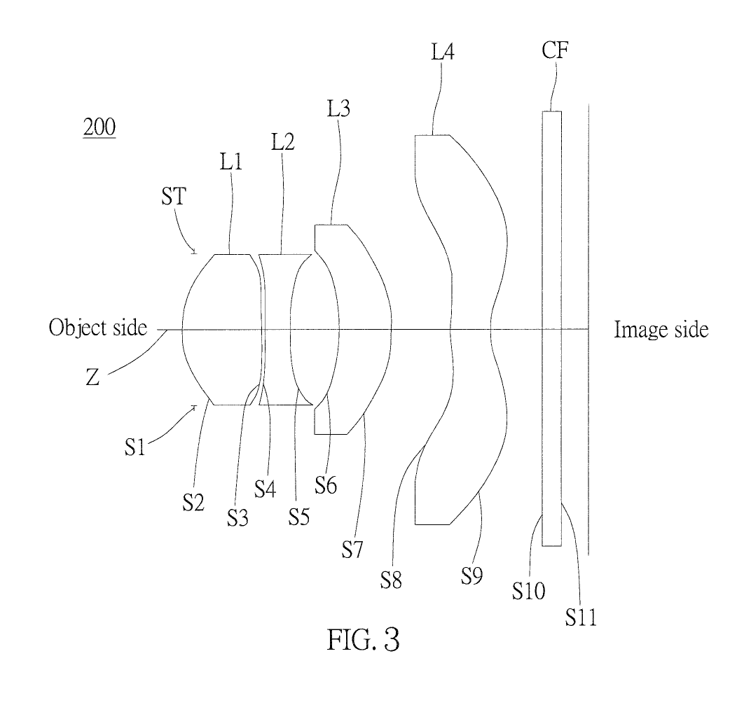

As shown in FIG. 3, an optical image pick-up lens 200 of the second preferred embodiment of the present includes, along an optical axis Z from an object side to an image side, an aperture ST, a first lens L1, a second lens L2, a third lens L3, a fourth lens L4, and an optical filter CF.

The first lens L1 is a positive plastic lens. In an embodiment, the first lens L1 is a meniscus lens having a convex surface S2 facing the object side and a concave surface S3 facing the image side. It provides the optical image pick-up lens 200 with a wide-angle mode. Both surfaces S2, S3 of the first lens L1 are aspheric surfaces to effectively fix the torsion problem in the wide-angle mode.

The second lens L2 is a negative plastic lens. In an embodiment, the second lens L2 is a biconcave lens with two aspheric surfaces S4, S5.

The third lens L3 is a positive glass lens. In an embodiment, the third lens L3 is a meniscus lens having a concave surface S6 facing the object side and a convex surface S7 facing the image side. Both surfaces S6, S7 of the third lens L3 are aspheric surfaces.

The fourth lens L4 is a plastic lens. In an embodiment, the fourth lens L4 has an aspheric surface S8 facing the object side, and the surface S8 has two inflection portions. Therefore, the surface S8 has a convex portion within the proximal inflection portion, a concave portion between the inflection portions, and a convex portion between the distal inflection portion and an edge of the lens L4. In other words, a radius of curvature of the surface S8 is gradually changed from positive to negative, and then changed to positive again from a center, where the optical axis Z passes, to an edge of the fourth lens L4. The fourth lens L4 has an aspheric surface S9 facing the image side, and the surface S9 has an inflection portion. Therefore, the surface S9 has a concave portion within the inflection portion and a convex portion between the inflection portion and the edge of the lens. As a result, the fourth lens L4 is negative at a central portion, and is positive at a margin portion. In other words, the fourth lens L4 is gradually changed from negative to positive from the center to the edge.

The optical image pick-up lens 200 further has the following characters:

1.7≦Nd3 (1)

2.35<f/R1<2.73 (2)

0.27<f1/f3<1.08 (3)

0.39<f/f3<1.15 (4)

0.83<f/TLL<0.88 (5)

where

Nd3 is the refractive index of the third lens L3;

f is the total focus length of the optical image pick-up lens 200;

R1 is the radius of curvature of the point on the surface S2 facing the object side of the first lens L1 where the optical axis Z passes;

f1 is the focus length of the first lens L1

f3 is the focus length of the third lens L3; and

TTL is the total length of the optical image pick-up lens 200.

In order to obtain a good optical performance, the focus length (f) of the optical image pick-up lens 200, the radius of curvature at the optical axis of each lens (R), the distance from the surface of the lens to the surface of the next lens (or to an image plane) (D), the refractive indexes of the lenses (Nd), and the Abbe number of the lenses (Vd) of the optical image pick-up lens 200 are shown in Table 3.

TABLE 3
f = 3.71 mm

| surface | R(mm) | D(mm) | material | Nd | Vd | Focus length | |
|---|---|---|---|---|---|---|---|
| S1 | ∞ | −0.209 | | | | | ST |
| S2 | 1.458 | 0.843 | plastic | 1.53 | 55.75 | 2.81 | L1 |
| S3 | 42.718 | 0.051 | | | | | |
| S4 | −27.017 | 0.302 | plastic | 1.64 | 22.46 | −6.66 | L2 |
| S5 | 5.163 | 0.585 | | | | | |
| S6 | −3.064 | 0.603 | glass | 1.81 | 40.95 | 10.06 | L3 |
| S7 | −2.427 | 0.621 | | | | | |
| S8 | 2.302 | 0.526 | plastic | 1.53 | 55.75 | −5.65 | L4 |
| S9 | 1.201 | 0.313 | | | | | |
| S10 | ∞ | 0.210 | glass | 1.5168 | 64.1 | | CF |
| S11 | ∞ | 0.479 | | | | | |

The depression z of the aspheric surfaces S2-S9 may be obtained by the following equation:

$$z = \frac{{ch}^{2}}{1 + \sqrt{1 - ( 1 + k ) {c}^{2} {h}^{2}}} + {α}_{2} {h}^{4} + {α}_{3} {h}^{6} + {α}_{4} {h}^{8} + {α}_{5} {h}^{10} + {α}_{6} {h}^{12}$$

where

z is the depression of the aspheric surface;

c is the reciprocal of radius of curvature;

h is the radius of aperture on the surface;

k is conic constant;

α2-α6 are coefficients of the radius of aperture h.

The conic constants (k) of the aspheric surfaces and the coefficients α2-α6 are shown in Table 4.

TABLE 4

| | S2 | S3 | S4 | S5 |
|---|---|---|---|---|
| K | 2.18918E−02 | 0.00000E+00 | 0.00000E+00 | −3.01085E+00 |
| α2 | −1.14681E−02 | −1.67001E−02 | 4.82486E−02 | 1.20476E−01 |
| α3 | 4.46336E−02 | −3.61630E−01 | −3.38368E−01 | −9.46023E−02 |
| α4 | −1.57887E−01 | 4.08490E−01 | 3.50011E−01 | 2.60919E−01 |
| α5 | 1.94149E−01 | −2.16773E−01 | −1.24419E−01 | −3.07809E−01 |
| α6 | 2.18918E−02 | 0.00000E+00 | 0.00000E+00 | −3.01085E+00 |
| | S6 | S7 | S8 | S9 |
| K | −8.58288E+01 | 2.77086E−01 | −9.88208E+00 | −5.58013E+00 |
| α2 | −3.54496E−01 | −8.93388E−02 | −3.08159E−01 | −1.24747E−01 |
| α3 | 6.16265E−01 | 8.25161E−02 | 1.43638E−01 | 4.58739E−02 |
| α4 | −9.34658E−01 | −6.60690E−02 | −3.04259E−02 | −1.03603E−02 |
| α5 | 7.98375E−01 | 4.08014E−02 | 3.23897E−03 | 1.24424E−03 |
| α6 | −8.58288E+01 | 2.77086E−01 | −9.88208E+00 | −5.58013E+00 |

With the designation of the lenses, the optical image pick-up lens 200 may work in wide-angle mode and has a short total length. Because the third lens L3 is made of glass, and its refractive index is greater than 1.7, it makes the optical image pick-up lens 200 have a high precision in optical axis calibration. Therefore, the optical image pick-up lens 200 would be helpful to a high definition and high quality of the image.

In an embodiment, the optical image pick-up lens 200 has the following characters:

Nd3=1.81 (1)

f/R1=2.712 (2)

f1/f3=0.279 (3)

f/f3=0.394 (4)

f/TLL=0.874 (5)

With the arrangement of the aperture ST and the lenses L1-L4, the optical image pick-up lens 200 would have a high performance in imaging. The maximum field curvature is about −0.006 mm and 0.06 mm (FIG. 4A), the maximum distortion is about −0.5% and 1.5% (FIG. 4B), the maximum chromatic aberration of magnification is about −3 μm and 3 μm (FIG. 4C), and the maximum spherical chromatic aberration is about −0.02 mm and 0.06 mm (FIG. 4D). In conclusion, according to the results shown in FIG. 4A to FIG. 4D, the optical image pick-up lens 200 has a high optical performance.

### Third Preferred Embodiment

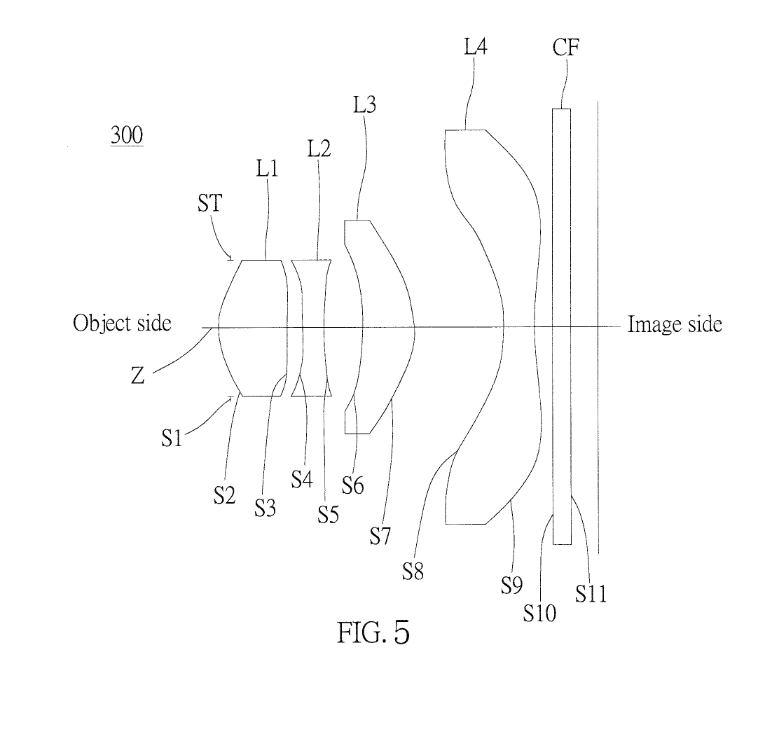

As shown in FIG. 5, an optical image pick-up lens 300 of the third preferred embodiment of the present includes, along an optical axis Z from an object side to an image side, an aperture ST, a first lens L1, a second lens L2, a third lens L3, a fourth lens L4, and an optical filter CF.

The first lens L1 is a positive plastic lens. In an embodiment, the first lens L1 is a meniscus lens having a convex surface S2 facing the object side and a concave surface S3 facing the image side. It provides the optical image pick-up lens 300 with a wide-angle mode. Both surfaces S2, S3 of the first lens L1 are aspheric surfaces to modify the torsion problem in the wide-angle mode.

The second lens L2 is a negative plastic lens. In an embodiment, the second lens L2 is a biconcave lens with two aspheric surfaces S4, S5.

The third lens L3 is a positive glass lens. In an embodiment, the third lens L3 is a meniscus lens having a concave surface S6 facing the object side and a convex surface S7 facing the image side. Both surfaces S6, S7 of the third lens L3 are aspheric surfaces.

The fourth lens L4 is a plastic lens. In an embodiment, the fourth lens L4 has an aspheric surface S8 facing the object side, and the surface S8 has an inflection portion. Therefore, the surface S8 has a concave portion within the inflection portion and a convex portion between the inflection portion and an edge of the lens L4. In other words, a radius of curvature of the surface S8 is gradually changed from to negative positive from a center, where the optical axis Z passes, to an edge of the fourth lens L4. The fourth lens L4 has an aspheric surface S9 facing the image side, and the surface S9 has an inflection portion. Therefore, the surface S9 has a convex portion within the inflection portion and a concave portion between the inflection portion and the edge of the lens. As a result, the fourth lens L4 is negative at a central portion, and is positive at a margin portion. In other words, the fourth lens L4 is gradually changed from negative to positive from the center to the edge.

The optical image pick-up lens 300 further has the following characters:

1.7≦Nd3 (1)

2.35<f/R1<2.73 (2)

0.27<f1/f3<1.08 (3)

0.39<f/f3<1.15 (4)

0.83<f/TLL<0.88 (5)

where

Nd3 is the refractive index of the third lens L3;

f is the total focus length of the optical image pick-up lens 300;

R1 is the radius of curvature of the point on the surface S2 facing the object side of the first lens L1 where the optical axis Z passes;

f1 is the focus length of the first lens L1

f3 is the focus length of the third lens L3; and

TTL is the total length of the optical image pick-up lens 300.

In order to obtain a good optical performance, the focus length (f) of the optical image pick-up lens 300, the radius of curvature at the optical axis of each lens (R), the distance from the surface of the lens to the surface of the next lens (or to an image plane) (D), the refractive indexes of the lenses (Nd), and the Abbe number of the lenses (Vd) of the optical image pick-up lens 300 are shown in Table 5.

TABLE 5
f = 3.71 mm

| surface | R(mm) | D(mm) | material | Nd | Vd | Focus length | |
|---|---|---|---|---|---|---|---|
| S1 | ∞ | −0.120 | | | | | ST |
| S2 | 1.529 | 0.750 | plastic | 1.53 | 55.7 | 3.53 | L1 |
| S3 | 6.698 | 0.191 | | | | | |
| S4 | −53.799 | 0.250 | plastic | 1.64 | 22.4 | −11.0 | L2 |
| S5 | 8.268 | 0.430 | | | | | |
| S6 | −3.510 | 0.594 | glass | 1.70 | 53.2 | 3.72 | L3 |
| S7 | −1.596 | 1.019 | | | | | |
| S8 | −2.645 | 0.350 | plastic | 1.53 | 55.7 | −2.78 | L4 |
| S9 | 3.554 | 0.200 | | | | | |
| S10 | ∞ | 0.210 | glass | 1.5168 | 64.1 | | CF |
| S11 | ∞ | 0.307 | | | | | |

The depression z of the aspheric surfaces S2-S9 may be obtained by the following equation:

$$z = \frac{{ch}^{2}}{1 + \sqrt{1 - ( 1 + k ) {c}^{2} {h}^{2}}} + {α}_{2} {h}^{4} + {α}_{3} {h}^{6} + {α}_{4} {h}^{8} + {α}_{5} {h}^{10} + {α}_{6} {h}^{12}$$

where

z is the depression of the aspheric surface;

c is the reciprocal of radius of curvature;

h is the radius of aperture on the surface;

k is conic constant;

α2-α6 are coefficients of the radius of aperture h.

The conic constants (k) of the aspheric surfaces and the coefficients α2-α6 are shown in Table 6.

TABLE 6

| | S2 | S3 | S4 | S5 |
|---|---|---|---|---|
| K | −0.3929894 | 0.00000E+00 | 0.00000E+00 | 0.00000E+00 |
| α2 | 0.011866073 | −0.10336476 | −0.14180227 | −0.01116757 |
| α3 | −0.03132668 | −0.04273774 | −0.19410789 | −0.07264118 |
| α4 | 0.071107555 | −0.15390058 | 0.21041903 | 0.14957249 |
| α5 | −0.07782464 | 0.10495532 | −0.01667649 | 0.022536598 |
| α6 | −0.00991565 | −0.00136771 | −0.00536022 | −0.02413429 |
| | S6 | S7 | S8 | S9 |
| K | 8.23557E+00 | −6.44418E+00 | 0.00000E+00 | −1.16546E+01 |
| α2 | 4.97604E−02 | −1.18607E−01 | −2.56537E−02 | −6.72661E−02 |
| α3 | −8.05280E−02 | 7.12682E−02 | 8.53252E−04 | 2.87303E−02 |
| α4 | 1.70897E−01 | −2.21968E−02 | 8.16364E−03 | −1.03579E−02 |
| α5 | −1.83093E−01 | 3.96281E−03 | −1.78026E−03 | 2.33531E−03 |
| α6 | 1.06718E−01 | 3.23949E−03 | −6.48569E−06 | −3.44618E−04 |

In an embodiment, the optical image pick-up lens 300 has the following characters:

Nd3=1.70 (1)

f/R1=2.353 (2)

f1/f3=0.946 (3)

f/f3=0.965 (4)

f/TLL=0.837 (5)

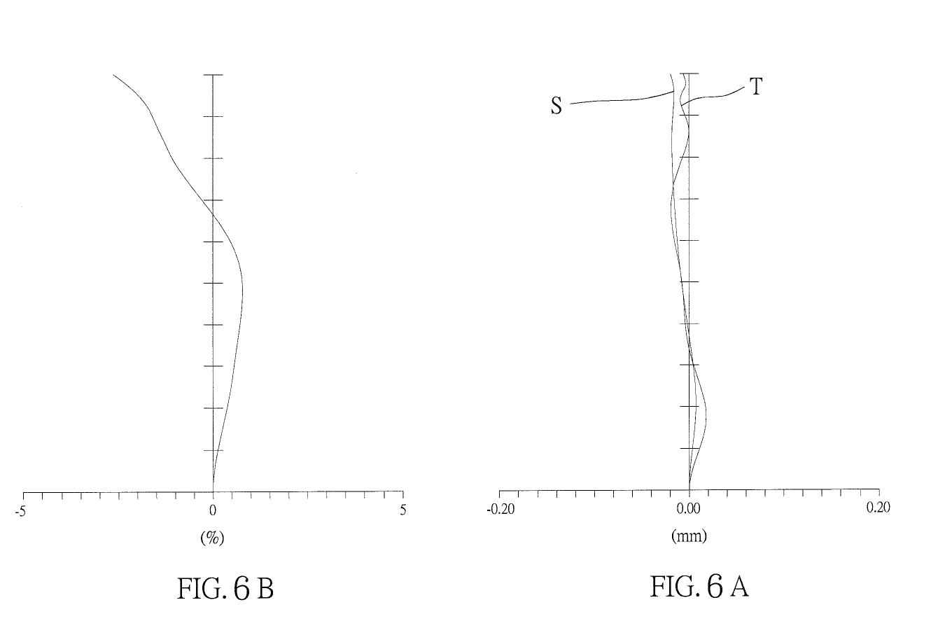

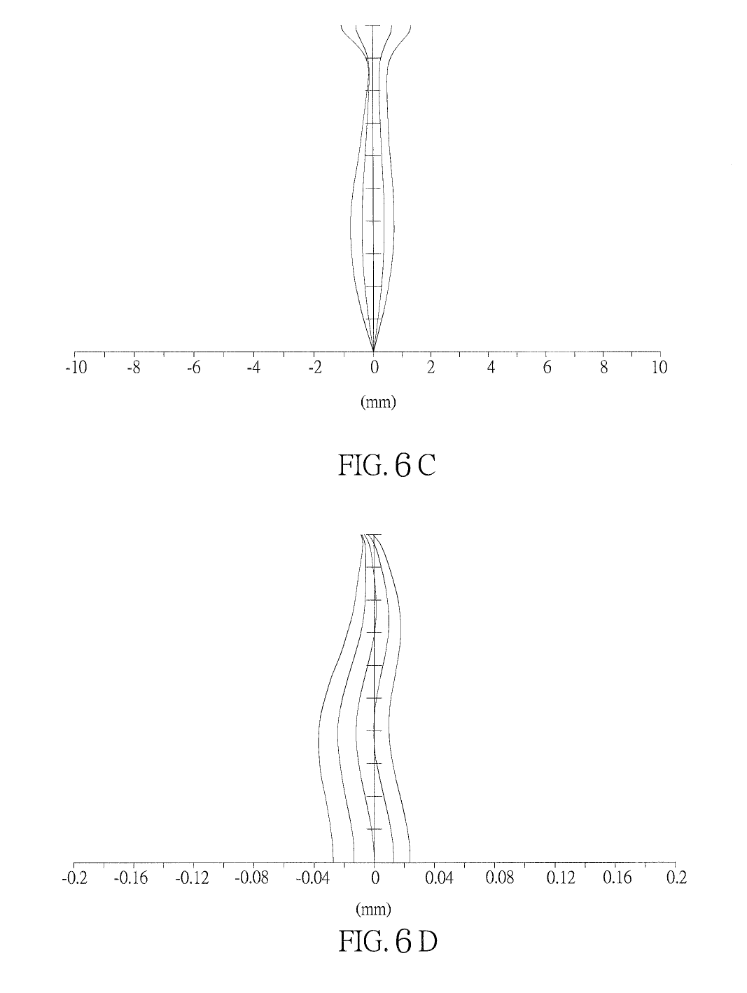

With the arrangement of the aperture ST and the lenses L1-L4, the optical image pick-up lens 300 would have a high performance in imaging. The maximum field curvature is about −0.04 mm and 0.02 mm (FIG. 6A), the maximum distortion is about −3% and 1% (FIG. 6B), the maximum chromatic aberration of magnification is about −2 μm and 2 μm (FIG. 6C), and the maximum spherical chromatic aberration is about −0.04 mm and 0.04 mm (FIG. 6D). In conclusion, according to the results shown in FIG. 6A to FIG. 6D, the optical image pick-up lens 300 has a high optical performance.

### Fourth Preferred Embodiment

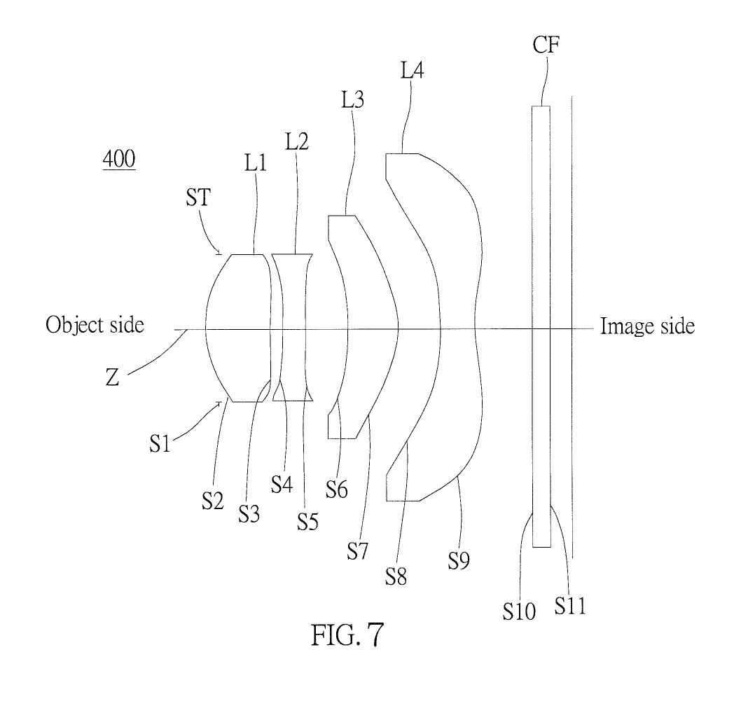

As shown in FIG. 7, an optical image pick-up lens 400 of the third preferred embodiment of the present includes, along an optical axis Z from an object side to an image side, an aperture ST, a first lens L1, a second lens L2, a third lens L3, a fourth lens L4, and an optical filter CF.

The first lens L1 is a positive plastic lens. In an embodiment, the first lens L1 is a meniscus lens having a convex surface S2 facing the object side and a concave surface S3 facing the image side. It provides the optical image pick-up lens 400 with a wide-angle mode. Both surfaces S2, S3 of the first lens L1 are aspheric surfaces to modify the torsion problem in the wide-angle mode.

The second lens L2 is a negative plastic lens. In an embodiment, the second lens L2 is a biconcave lens with two aspheric surfaces S4, S5.

The third lens L3 is a positive glass lens. In an embodiment, the third lens L3 is a meniscus lens having a concave surface S6 facing the object side and a convex surface S7 facing the image side. Both surfaces S6, S7 of the third lens L3 are aspheric surfaces.

The fourth lens L4 is a plastic lens. In an embodiment, the fourth lens L4 has an aspheric surface S8 facing the object side, and the surface S8 has an inflection portion. Therefore, the surface S8 has a concave portion within the inflection portion and a convex portion between the inflection portion and an edge of the lens L4. In other words, a radius of curvature of the surface S8 is gradually changed from to negative positive from a center, where the optical axis Z passes, to an edge of the fourth lens L4. The fourth lens L4 has an aspheric surface S9 facing the image side, and the surface S9 has an inflection portion. Therefore, the surface S9 has a convex portion within the inflection portion and a concave portion between the inflection portion and the edge of the lens. As a result, the fourth lens L4 is negative at a central portion, and is positive at a margin portion. In other words, the fourth lens L4 is gradually changed from negative to positive from the center to the edge.

The optical image pick-up lens 400 further has the following characters:

1.7≦Nd3 (1)

2.35<f/R1<2.73 (2)

0.27<f1/f3<1.08 (3)

0.39<f/f3<1.15 (4)

0.83<f/TLL<0.88 (5)

where

Nd3 is the refractive index of the third lens L3;

f is the total focus length of the optical image pick-up lens 400;

R1 is the radius of curvature of the point on the surface S2 facing the object side of the first lens L1 where the optical axis Z passes;

f1 is the focus length of the first lens L1

f3 is the focus length of the third lens L3; and

TTL is the total length of the optical image pick-up lens 400.

In order to obtain a good optical performance, the focus length (f) of the optical image pick-up lens 400, the radius of curvature at the optical axis of each lens (R), the distance from the surface of the lens to the surface of the next lens (or to an image plane) (D), the refractive indexes of the lenses (Nd), and the Abbe number of the lenses (Vd) of the optical image pick-up lens 400 are shown in Table 7.

TABLE 7
f = 3.71 mm

| surface | R(mm) | D(mm) | material | Nd | Vd | Focus length | |
|---|---|---|---|---|---|---|---|
| S1 | ∞ | −0.180 | | | | | ST |
| S2 | 1.426 | 0.736 | plastic | 1.53 | 55.7 | 3.39 | L1 |
| S3 | 5.500 | 0.158 | | | | | |
| S4 | −60.852 | 0.250 | plastic | 1.64 | 22.4 | −12.18 | L2 |
| S5 | 9.119 | 0.516 | | | | | |
| S6 | −3.092 | 0.575 | glass | 1.9 | 31 | 3.13 | L3 |
| S7 | −1.613 | 0.514 | | | | | |
| S8 | −4.421 | 0.400 | plastic | 1.53 | 55.75 | −2.95 | L4 |
| S9 | 2.525 | 0.672 | | | | | |
| S10 | ∞ | 0.210 | glass | 1.5168 | 64.1 | | CF |
| S11 | ∞ | 0.268 | | | | | |

The depression z of the aspheric surfaces S2-S9 may be obtained by the following equation:

$$z = \frac{{ch}^{2}}{1 + \sqrt{1 - ( 1 + k ) {c}^{2} {h}^{2}}} + {α}_{2} {h}^{4} + {α}_{3} {h}^{6} + {α}_{4} {h}^{8} + {α}_{5} {h}^{10} + {α}_{6} {h}^{12}$$

wherein

z is the depression of the aspheric surface;

c is the reciprocal of radius of curvature;

h is the radius of aperture on the surface;

k is conic constant;

α2-α6 are coefficients of the radius of aperture h.

The conic constants (k) of the aspheric surfaces and the coefficients α2-α6 are shown in Table 8.

TABLE 8

| | S2 | S3 | S4 | S5 |
|---|---|---|---|---|
| K | −2.24360E−01 | 0.00000E+00 | 0.00000E+00 | 0.00000E+00 |
| α2 | 1.05941E−02 | −1.00521E−01 | −1.24602E−01 | 3.49650E−03 |
| α3 | −3.35952E−02 | −7.51076E−02 | −2.00053E−01 | −4.72656E−02 |
| α4 | 8.31022E−02 | −1.41355E−01 | 2.49955E−01 | 1.77631E−01 |
| α5 | −9.15791E−02 | 9.57952E−02 | −6.80857E−02 | 2.11658E−02 |
| α6 | −9.91565E−03 | −1.36771E−03 | −5.36022E−03 | −2.41343E−02 |
| | S6 | S7 | S8 | S9 |
| K | 6.12857E+00 | −5.75821E+00 | 0.00000E+00 | −1.15405E+01 |
| α2 | 4.59913E−02 | −8.98870E−02 | −7.00519E−02 | −8.27570E−02 |
| α3 | −6.22859E−02 | 5.81458E−02 | 2.52071E−03 | 2.46259E−02 |
| α4 | 1.49480E−01 | −2.26242E−02 | 8.90040E−03 | −8.28954E−03 |
| α5 | −1.73772E−01 | 3.71169E−03 | −1.66145E−03 | 2.01535E−03 |
| α6 | 1.06718E−01 | 3.27232E−03 | −7.23813E−06 | −3.55587E−04 |

In an embodiment, the optical image pick-up lens 400 has the following characters:

Nd3=1.90 (1)

f/R1=2.517 (2)

f1/f3=1.083 (3)

f/f3=1.150 (4)

f/TLL=0.837 (5)

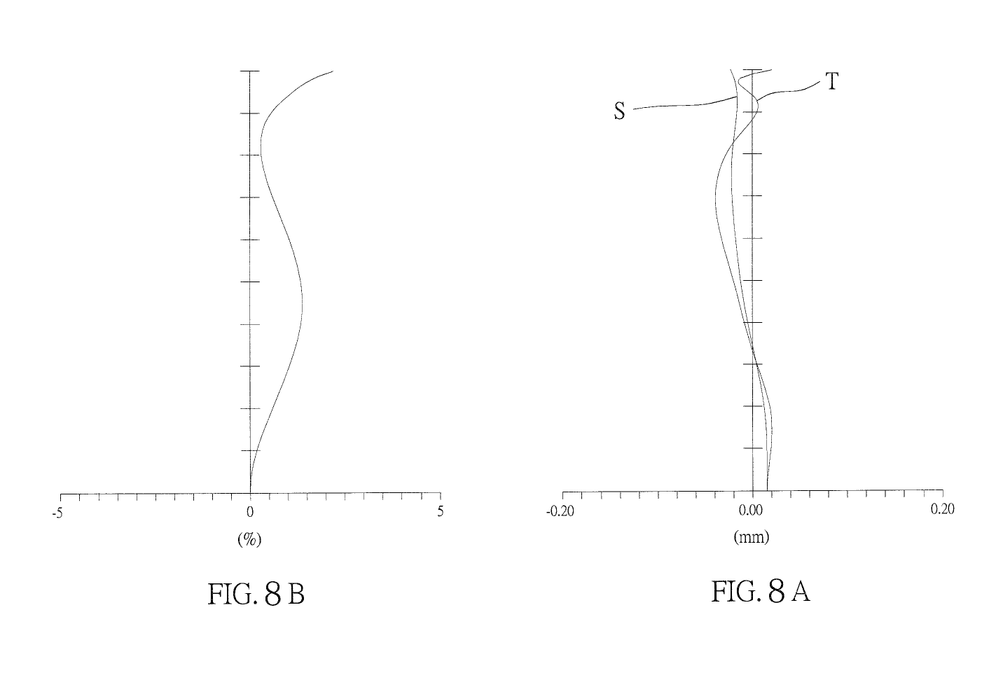

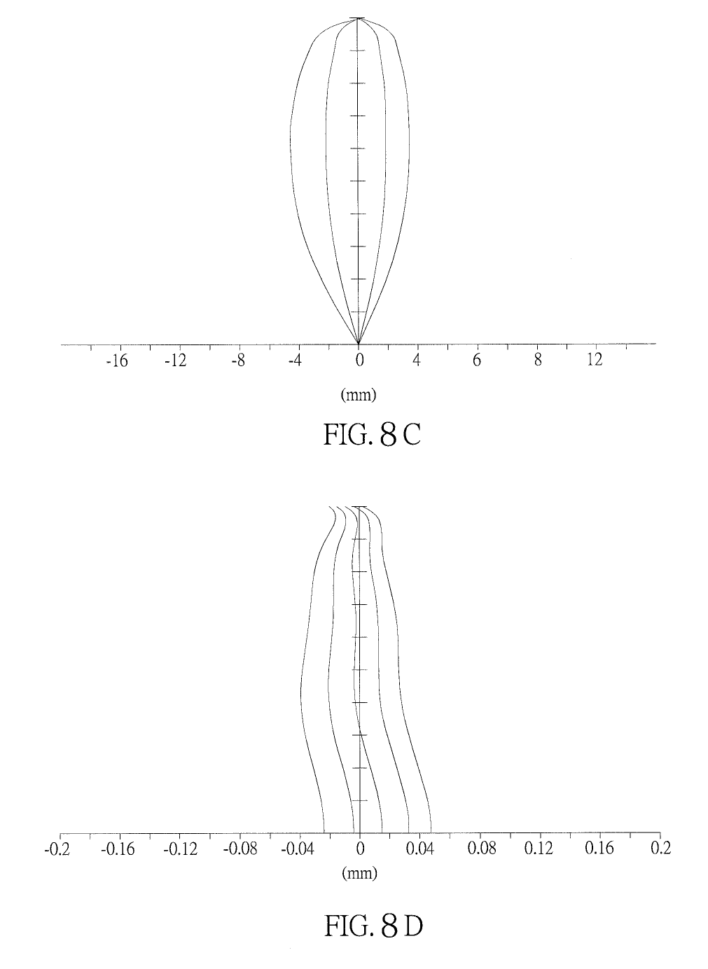

With the arrangement of the aperture ST and the lenses L1-L4, the optical image pick-up lens 400 would have a high performance in imaging. The maximum field curvature is about −0.04 mm and 0.02 mm (FIG. 8A), the maximum distortion is about −0.5% and 2.5% (FIG. 8B), the maximum chromatic aberration of magnification is about −6 μm and 4 μm (FIG. 8C), and the maximum spherical chromatic aberration is about −0.04 mm and 0.06 mm (FIG. 8D). In conclusion, according to the results shown in FIG. 8A to FIG. 8D, the optical image pick-up lens 400 has a high optical performance.

The description above is a few preferred embodiments of the present invention and the equivalence of the present invention is still in the scope of claim construction of the present invention.

What is claimed is:

1. An optical image pick-up lens, in order along an optical axis from an object side to an image side, comprising:
an aperture;
a first lens, which is a positive plastic meniscus lens having a convex surface facing the object side and a concave surface facing the image side, wherein at least one of the surfaces of the first lens is aspheric;
a second lens, which is a negative plastic biconcave lens having at least an aspheric surface;
a third lens, which is a positive glass meniscus lens having a concave surface facing the object side and a convex surface facing the image side, wherein at least one of the surfaces of the third lens is aspheric; and
a fourth lens, which is a plastic lens having an aspheric surface facing the object side, wherein the aspheric surface has an inflection portion, so that the fourth lens is gradually changed from positive to negative from a center, where the optical axis passes, to an edge of the fourth lens;
wherein the optical image pick-up lens satisfies:
1.7≦Nd3
where Nd3 is a refractive index of the third lens.

2. The optical image pick-up lens as defined in claim 1, wherein both the surfaces of the first lens are aspheric.

3. The optical image pick-up lens as defined in claim 1, wherein both the surfaces of the second lens are aspheric.

4. The optical image pick-up lens as defined in claim 1, wherein both the surfaces of the third lens are aspheric.

5. The optical image pick-up lens as defined in claim 1, wherein the aspheric surface of the fourth lens has a convex portion at a central portion, through which the optical axis passes.

6. The optical image pick-up lens as defined in claim 5, wherein a radius of curvature of the aspheric surface of the fourth lens is gradually changed from positive to negative, and then changed to positive again from the center to the edge.

7. The optical image pick-up lens as defined in claim 1, wherein the aspheric surface of the fourth lens has a concave portion at a central portion, through which the optical axis passes.

8. The optical image pick-up lens as defined in claim 7, wherein a radius of curvature of the aspheric surface of the fourth lens is gradually changed from negative to positive from the center to the edge.

9. The optical image pick-up lens as defined in claim 1, wherein the fourth lens has a surface facing the image side, and the surface has a concave portion at a central portion, through which the optical axis passes.

10. The optical image pick-up lens as defined in claim 9, wherein a radius of curvature of the surface facing the image side of the fourth lens is gradually changed from negative to positive from the center to the edge.

11. The optical image pick-up lens as defined in claim 1, wherein the optical image pick-up lens further satisfies:
2.35<f/R1<2.73
where f is a total focus length of the optical image pick-up lens, and R1 is a radius of curvature at a center of the surface facing the object side of the first lens where the optical axis passes.

12. The optical image pick-up lens as defined in claim 1, wherein the optical image pick-up lens further satisfies:
0.27<f1/f3<1.08
where f1 is a focus length of the first lens, and f3 is a focus length of the third lens.

13. The optical image pick-up lens as defined in claim 1, wherein the optical image pick-up lens further satisfies:
0.39<f/f3<1.15
where f is a total focus length of the optical image pick-up lens, and f3 is a focus length of the third lens.

14. The optical image pick-up lens as defined in claim 1, wherein the optical image pick-up lens further satisfies:
0.83<f/TLL<0.88
where f is a total focus length of the optical image pick-up lens, and TTL is a total length of the optical image pick-up lens.
